(19) United States
(12) Patent Application Publication
(10) Pub. No.: US 2013/0216030 A1
(43) Pub. Date: Aug. 22, 2013

(54) METHODS FOR DIRECTLY ACCESSING THE VOICEMAIL OF A CALL RECIPIENT AND FOR LEAVING A VOICE MESSAGE ON A VOICEMAIL

(71) Applicants: Didier Derderian, Le Castellet (FR); Thierry Francois, Paris (FR); Stéphane Raimondeau, Le Poire Sur Vie (FR)

(72) Inventors: Didier Derderian, Le Castellet (FR); Thierry Francois, Paris (FR); Stéphane Raimondeau, Le Poire Sur Vie (FR)

(73) Assignee: NEOCOM MULTIMEDIA, MARSEILLE (FR)

(21) Appl. No.: 13/575,879

(22) PCT Filed: Jan. 28, 2011
(86) PCT No.: PCT/FR2011/050175

§ 371 Date: May 9, 2013

(30) Foreign Application Priority Data
Jan. 28, 2010 (FR) 1050589

(51) Int. Cl. H04M 3/533

(52) U.S. Cl. CPC H04M 3/533
USPC 379/88.18

(57) ABSTRACT

The invention serves to avoid causing the destination telephone from ringing while performing voicemail advertising. The method makes it possible to gain direct access to the voice mailbox of a telephone line that is configured, while busy, to redirect incoming calls to its voice mailbox. The method consists in executing the following steps:
triggering a first group of calls to the line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the line to ring.

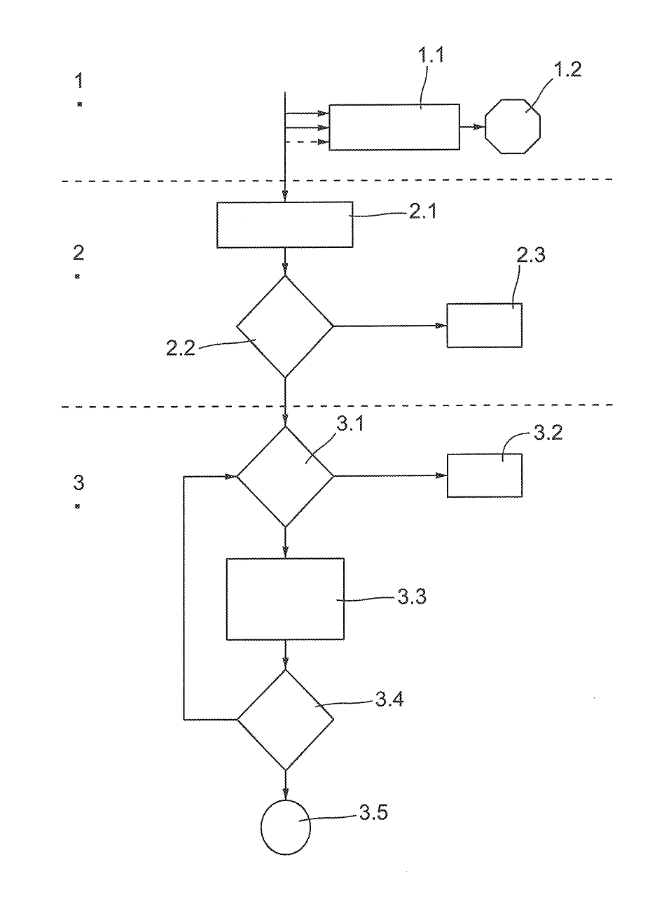

The invention also protects a computer program for implementing the method, and the server hosting it.

### BACKGROUND OF THE INVENTION

There exist numerous circumstances in which it would be useful to be able to reach a recipient's voice mailbox directly. This applies in particular when delivering advertising messages, or more commonly, in order to give information to a recipient who is known not to be available to answer the telephone.

With some telephone operators, there already exists a solution that consists in accessing the computer servers that host subscribers' voice mailboxes in order to add voice messages thereto so as to provide subscribers with information or advertising. That involves using computer means to access the subscriber voice message storage space directly. Without adaptation, that solution cannot operate with any telephone operator.

### OBJECT AND SUMMARY OF THE INVENTION

The present invention seeks to provide a multi-operator solution that is independent of the hardware and software architecture of a telephone operator and that can operate with any subscriber as the recipient, providing the subscriber uses a telephone line that is configured, when the line is busy, to redirect incoming telephone calls to a voice mailbox.

The present invention provides a method of directly accessing the voice mailbox of a telephone line that is configured, while the line is busy, to redirect incoming telephone calls to its voice mailbox, wherein the method consists in executing the following steps:
triggering a first group of calls to the line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the target line to ring.

By means of this method, it is possible to reach a recipient's mailbox directly without causing the recipient's telephone to ring, and thus without causing disturbance.

Once the mailbox has started, it suffices to listen to its greeting message and then to place the desired voice message.

On the assumption that the direct access to a recipient's voice mailbox is used for automatically placing a pre-recorded message, the invention also provides a method that makes it possible to wait for the end of a greeting voice message before sending the voice message.

The invention thus also provides a method of automatically placing a pre-recorded voice message in a voice mailbox of a line that is configured, while the line is busy, to redirect incoming telephone calls to its voice mailbox. The method of directly accessing the voice mailbox is executed initially, and then on the new call, the following steps are executed to send a pre-recorded voice message automatically at the end of the greeting message of the voice mailbox:
listening to the line;
waiting for a period of silence having at least a predetermined duration before moving on to the following step;
sending the pre-recorded voice message over the line;
while sending the message, continuing to listen to the line;
if the silence on the line is interrupted, returning to the first step of listening to the line; and
then stopping the new call.

It is thus possible to place a pre-recorded voice message in a recipient's mailbox without causing the recipient's telephone to ring.

The steps that make it possible to send the pre-recorded voice message automatically at the end of the greeting message of the voice mailbox serve to detect the end of a greeting message automatically and to begin sending the predetermined voice message to a recipient's mailbox at the right moment.

The invention finds a particularly advantageous application when pre-recorded messages are placed in the mailboxes of a large number of recipients, e.g. for advertising purposes.

Under such circumstances, the invention makes it possible with voice messages to perform the equivalent of advertising in written form sent to recipients entered in a database.

It can be understood that the invention operates regardless of the telephone operators with whom the recipients of the advertising are subscribers.

In order to implement the invention, it is possible to use telephone lines that may be analog or digital, and that are organized as a single line, or as a line group.

In a variant, a pre-recorded voice message is placed automatically in a voice mailbox of a line that is configured, while the line is busy, to redirect incoming telephone calls to the voice mailbox, initially by executing a method of the invention for directly accessing the voice mailbox, and then, with the new call, by placing the pre-recorded voice message using a method of automatically sending the pre-recorded voice message other than that described above.

The method may be implemented by voice server software making it possible, by computer programming, to automate the various steps of the methods. For this purpose, it is possible for example to use the open-source software known as Asterisk.

From a hardware point of view, the voice server software may be executed on a computer server containing one or more voice cards. For this purpose, it is possible to use cards of the Digium brand in order to transform telephone signals into information that can be understood by the voice server software.

The invention also provides a computer program for implementing the above-described method for directly accessing the voice mailbox of a line that is configured, while the line is busy, to redirect incoming telephone calls to its voice mailbox, wherein the program comprises instructions for:
triggering a first group of calls to the line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the line to ring.

The invention also provides a computer program for implementing the above-described method for automatically placing a pre-recorded voice message in a voice mailbox of a line that is configured, while the line is busy, to redirect incoming telephone calls to its voice mailbox, the method comprising instructions for:
triggering a first group of calls to the line;
waiting for a first predetermined duration that is long enough to have placed the line in the busy state;
triggering a new call to the line;
stopping the calls of the first group at the end of a second predetermined duration that is longer than the first duration, but short enough to avoid causing the telephone of the line to ring;
listening to the line;
waiting for a period of silence having at least a predetermined duration before moving on to the following step;
sending the pre-recorded voice message over the line;
while sending the message, continuing to listen to the line; and
if the silence on the line is interrupted, returning to the step of listening to the line.

The invention also provides computer servers hosting the above-described programs.

### BRIEF DESCRIPTION OF THE DRAWINGS

In order to better understand the invention, there follows a description of an implementation given with reference to the accompanying drawing, which comprises a single figure containing a flowchart of the individual steps executed by the vocal server software relative to a line referred to as the “target” line.

### MORE DETAILED DESCRIPTION

The execution of a method of automatically depositing a pre-recorded voice message on a destination voice mailbox is subdivided into three stages, namely a stage 1 of accessing the target line, a stage 2 of accessing the voice mailbox, and a stage 3 of automatically sending a message to the voice mailbox.

During the stage 1 of accessing the target line, a first group of telephone calls to the target line is triggered (step 1.1). These first calls may be referred to as “blocking” calls. Each of these blocking calls is of a predetermined duration that is short enough to avoid ringing the telephone that is connected to the target line, but long enough for the line to be put into a busy state as a result of the simultaneous incoming calls.

Depending on the type of subscription and on the operator in question, one blocking call may suffice, or else several may be necessary. For example, if the line is capable of receiving two simultaneous calls, then at least two simultaneous calls are essential for blocking the line. In addition, the inventors have observed that the fact of sending a plurality of blocking calls that is strictly greater than the number of incoming calls authorized on the target line statistically improves the effectiveness of the method.

Before stopping the blocking calls (step 1.2), i.e. during the above-defined predetermined time period, the method enters stage 2 by triggering a new call (step 2.1) to the target line. Since this new call reaches a busy line, it is sent to the voice mailbox of the target line, which begins to deliver a greeting message (step 2.2).

In the event of failing to access the voice mailbox (step 2.3), the process stops, and the call may be renewed subsequently (by a re-start process that is not described). If access is successful, the method moves on to stage 3 of automatically sending a message to the voice mailbox. This stage begins with a first step 3.1 of listening to the telephone line and of waiting for a period of silence of at least a predetermined duration (e.g. 3 seconds). Until a period of silence of this duration has been listened to on the line, the method does not move on to the following step. If the wait is too long, e.g. longer than 2 minutes, then the method is interrupted (step 3.2) and the call to the same target line needs to be repeated subsequently.

If a period of silence having at least the above-indicated duration appears, then reading of the pre-recorded message is triggered (step 3.3), thereby enabling the voice message to be sent over the line. While the voice message is being sent, the target line continues to be listened to (step 3.4). If the voice mailbox has indeed moved on to the recording stage as a result of the greeting message being delivered in full, then the line remains silent and the voice message sent over the line is recorded in the mailbox. In contrast, if the silence on the telephone line is interrupted, that means that the previously-detected silence did not mark the end of the voice message, and the method returns to step 3.1 of listening to the telephone line and of waiting for a period of silence that is sufficiently long.

It is only when a new period of silence is once more detected that the pre-recorded voice message is once more delivered in order to be recorded in the mailbox, using the same process as described above.

Once the entire pre-recorded voice message has been delivered, it is assumed that the message has been appropriately recorded in the mailbox of the target line, and the method stops (step 3.5).

It can be seen that the above-described method does not depend on the software or hardware architecture of the operator with whom the recipient of the call is a subscriber.

Naturally, the above-described method may be implemented to access a recipient's mailbox directly and to leave a message in the mailbox that is dictated orally by a user.

Under such circumstances, only stages 1 and 2 of accessing the target line and of accessing the mailbox are implemented.

Naturally, the above-described implementation does not present any limiting nature and it may receive any desirable modification without thereby going beyond the ambit defined by the accompanying claims.

In particular, the invention applies equally well to fixed telephone lines and to mobile telephone lines.

Furthermore, provision may be made to use a method of automatically sending a pre-recorded voice message at the end of a greeting message of a voice mailbox, which method consists in executing the following steps:
listening to the line;
waiting for a period of silence having at least a predetermined duration before moving on to the following step;
sending the pre-recorded voice message over the line;
while sending the message, continuing to listen to the line; and
if the silence on the line is interrupted, returning to the first step of listening to the line;
independently of the method of directly accessing the voice mailbox of a telephone line that is configured, while the line is busy, to redirect incoming telephone calls to its voice mailbox, which method consists in executing the following steps:
triggering a first group of calls to the line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the target line to ring.

In analogous manner, provision may be made to run a computer program for implementing the above-described method for automatically sending a pre-recorded voice message at the end of a greeting message of a voice mailbox, the program comprising instructions for:
listening to the line;
waiting for a period of silence having at least a predetermined duration before moving on to the following step;
sending the pre-recorded voice message over the line;
while sending the message, continuing to listen to the line; and
if the silence on the line is interrupted, returning to the first step of listening to the line;
independently of the computer program for implementing the above-described method for directly accessing the voice mailbox of a line that is configured, while the line is busy, to redirect incoming telephone calls to its voice mailbox, which program comprises instructions for:
triggering a first group of calls to the line;
waiting for a first predetermined duration that is long enough to have placed the line in the busy state;
triggering a new call, to the line; and
stopping the calls of the first group at the end of a second predetermined duration that is longer than the first duration, but short enough to avoid causing the telephone of the target line to ring.

What is claimed is:

1. A method of directly accessing the voice mailbox of a telephone line that is configured, while the line is busy, to redirect incoming telephone calls to its voice mailbox, wherein the method consists in executing the following steps:
triggering a first group of calls to the target line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the line to ring.

2. A method of automatically placing a pre-recorded voice message in a voice mailbox of a line that is configured, while the line is busy, to redirect incoming telephone calls to its voice mailbox, wherein the method according to claim 1 is executed initially in order to access the voice mailbox directly, and then on the new call, the following steps are executed to send a pre-recorded voice message automatically at the end of the greeting message of the voice mailbox:
listening to the line;
waiting for a period of silence having at least a predetermined duration before moving on to the following step;
sending the pre-recorded voice message over the line;
while sending the message, continuing to listen to the line;
if the silence on the line is interrupted, returning to the first step of listening to the line; and
then stopping the new call.

3. A computer program for implementing the method according to claim 1 for directly accessing the voice mailbox of a telephone line that is configured, while the line is busy, to redirect incoming telephone calls to its voice mailbox, wherein the program comprises instructions for:
triggering a first group of calls to the target line;
waiting for a first predetermined duration that is long enough to have placed the line in the busy state;
triggering a new call to the line; and
stopping the calls of the first group at the end of a second predetermined duration that is longer than the first duration, but short enough to avoid causing the telephone of the line to ring.

4. A computer program for implementing the method according to claim 2 for automatically placing a pre-recorded voice message on a voice mailbox of a line that is configured, while the line is busy, to redirect incoming telephone calls to its voice mailbox, the method comprising instructions for:
triggering a first group of calls to the line;
waiting for a first predetermined duration that is long enough to have placed the line in the busy state;
triggering a new call to the line;
stopping the calls of the first group at the end of a second predetermined duration that is longer than the first duration, but short enough to avoid causing the telephone of the line to ring;
listening to the line;
waiting for a period of silence having at least a predetermined duration before moving on to the following step;
sending the pre-recorded voice message over the line;
while sending the message, continuing to listen to the line; and
if the silence on the line is interrupted, returning to the step of listening to the line.

5. A computer server hosting a computer program according to claim 3.
